(19) United States
(12) Patent Application Publication
(10) Pub. No.: US 2014/0365188 A1
(43) Pub. Date: Dec. 11, 2014

(54) SPARSE FINITE-DIFFERENCE TIME DOMAIN SIMULATION

(71) Applicant: ACACIA COMMUNICATIONS INC., MAYNARD, MA (US)

(72) Inventor: Christopher DOERR, MAYNARD, MA (US)

(21) Appl. No.: 14/298,856

(22) Filed: Jun. 6, 2014

Related U.S. Application Data
(60) Provisional application No. 61/832,014, filed on Jun. 6, 2013.

(51) Int. Cl. G06F 17/50

(52) U.S. Cl. CPC G06F 17/5018
USPC 703/2

(57) ABSTRACT

Disclosed are accurate and fast methods for simulating electromagnetic wave propagation which employ an omnidirectional vectorial simulation and which measure all frequencies at once.

### CROSS REFERENCE TO RELATED APPLICATIONS

This application claims the benefit of U.S. Provisional Patent application Ser. No. 61/832,014 filed Jun. 6, 2013 which is incorporated by reference in its entirety as if set forth at length herein.

### TECHNICAL FIELD

This disclosure relates generally to electromagnetic wave propagation. More particularly, this disclosure pertains to accurate and fast methods for simulating electromagnetic waves in electronic and optical circuits which employs an omnidirectional vectorial simulation and which measures all frequencies at once.

### BACKGROUND

Microwave and radio components oftentimes makes use of transmission lines, resonators, and other components. Contemporary optical communications and other photonic systems oftentimes make extensive use of photonic integrated circuits. Accordingly, methods that facilitate the simulation of such electronic and photonic integrated circuits would represent a welcome addition to the art.

### SUMMARY

An advance in the art is made according to an aspect of the present disclosure directed to methods that facilitate simulation of electromagnetic waves in structures. And while the methods according to the present disclosure exhibit the high accuracy associated with contemporary finite-difference time-domain (FDTD) methods, they advantageously exhibit a computational speed much greater than prior art method(s).

Operationally, a method according to the present disclosure maintains a list of active electric field (E-field) and magnetic field (H-field) points rather than the full array of points as performed in the prior art. This list of active E-field and H-field points so maintained we call “sparse” FDTD—in an analogous manner to matrix operations that perform calculations on matrices comprising mostly empty elements.

For each time step we start with the list of active E-field points and determine new H-field points based on these E-field points in the active list. This oftentimes results in the generation of new, active H-field points. Next, we then iterate through all of the H-field points and determine new E-field points. As before, this will likely result in a set of new points.

We then remove all the points that exhibit an optical power below a certain threshold value. To make the procedure more stable, prior to removal points may be attenuated over several time steps. The removed points may leave “holes” in the list which are tracked such that they may be refilled, or the lists may be resorted. The cycle repeats. {really well written!}

### BRIEF DESCRIPTION OF THE DRAWING

A more complete understanding of the present disclosure may be realized by reference to the accompanying drawing in which:

FIG. 1 shows a schematic flowchart of depicting an illustrative example of a method according to an aspect of the present disclosure; and

FIG. 2 shows a schematic illustration of an exemplary computer system upon which a method according to the present disclosure may execute.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not be shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we begin by noting that a finite-difference time domain (FDTD) simulation method was proposed by Yee in 1996 (See, e.g., K. S. Yee, “Numerical Solution of Initial Boundary Value Problems Involving Maxwell's Equations in Isotropic Media,” IEEE Transactions on Antennas and Propagation, 1966.) It is a numerical analysis technique used for modeling computational electrodynamics. As those skilled in the art will readily appreciate, the FDTD method disclosed by Yee directly discretizes Maxwell's equations and simulates them in the time domain. It is a very accurate electromagnetic simulation and is widely used in a variety of electromagnetic problems from radio to optical frequencies.

With respect to optics, those skilled in the art will further appreciate that because of its accuracy it is extensively used to simulate high-index-contrast waveguides, such as employed in silicon photonics. Some commercially available optical simulation packages—such as LUMERICAL—are constructed on FDTD.

Despite its widespread use, a very significant drawback of FDTD is that it is an extremely slow method. One reason for this slowness is because for each time step, an entire area (for 2D problems), or an entire volume (for 3D problems) is calculated. Consequently, contemporary FDTD simulations are limited in area to about 20×20 μm². The simulation of a typical photonic integrated circuit (PIC) area much larger than that may take several days' computation time.

Operationally, and as those skilled in the art will readily appreciate, FDTD employs a standard Cartesian Yee cell about which electric and magnetic field vector components are distributed. Visualized as a cubic voxel, the electric field (E-field) components form edges of the cube, and the magnetic field (H-field) components form normals to the faces of the cube. A three-dimensional space lattice consists of a multiplicity of such Yee cells. An electromagnetic wave interaction structure is mapped into the space lattice by assigning appropriate values of permittivity to each electric field component, and permeability to each magnetic field component. {nice!}

To implement an FDTD solution a computational domain must first be established. The computational domain is simply the physical region over which the simulation will be performed. The E and H fields are determined at every point in space within that computational domain. Of course, the material of each cell within the computational domain must be specified. Typically, the material is either free-space (air), metal, semiconductor, or dielectric. Any material can be used as long as the permeability, permittivity, and conductivity are specified.

Once the computational domain and the grid materials are established, a source is specified. The source can be, e.g., current on a wire, applied electric field or impinging wave. In the latter case FDTD can be used to simulate light scattering from arbitrary shaped objects, planar periodic structures at various incident angles as well as a photonic band structure of infinite-periodic structures.

Since the E and H fields are determined directly, the output of the simulation is usually the E or H field at a point or a series of points within the computational domain. The simulation evolves the E and H fields forward in time. From the E and H fields one can calculate, e.g., the transmission through a structure.

Advantageously, the slowness of contemporary FDTD method(s) are overcome according to the present disclosure wherein an FDTD method is employed and calculation(s) in the area or volume (as the specific case may be) is performed only when a field is above a particular threshold. This changes each time step of the method.

Operationally, a method according to the present disclosure maintains a list of active electric field (E field) and magnetic (H field) points rather than the full array of points. This list of active E-field and H-filed points so maintained we call “sparse” FDTD—in an analogous manner to matrix operations that perform calculations on matrices comprising mostly empty elements.

For 3D simulations, there are 6 amplitudes for the field that must be tracked: Ex, Ey, Ez, Hx, Hy, and Hz. For 2D simulations (assuming the x-y plane) there are 3 amplitudes for the field that must be tracked: Ex, Ey, and Hz or alternatively Ez, Hx, and Hy. Furthermore, if the material is dispersive, one must keep track of additional time-dependent variables.

The differential form of Maxwell's equations relating to the 6 field components (assuming static, isotropic materials are represented by:

$$- {μ}_{0} \frac{\partial {H}_{x}}{\partial t} = \frac{\partial {E}_{z}}{\partial y} - \frac{\partial {E}_{y}}{\partial z} \\ - {μ}_{0} \frac{\partial {H}_{y}}{\partial t} = \frac{\partial {E}_{x}}{\partial z} - \frac{\partial {E}_{z}}{\partial x} \\ - {μ}_{0} \frac{\partial {H}_{z}}{\partial t} = \frac{\partial {E}_{y}}{\partial x} - \frac{\partial {E}_{x}}{\partial y}$$

$${ɛ}_{0} {ɛ}_{r} \frac{\partial {E}_{x}}{\partial t} = \frac{\partial {H}_{z}}{\partial y} - \frac{\partial {H}_{y}}{\partial z}$$

$${ɛ}_{0} {ɛ}_{r} \frac{\partial {E}_{y}}{\partial t} = \frac{\partial {H}_{x}}{\partial z} - \frac{\partial {H}_{z}}{\partial x}$$

$${ɛ}_{0} {ɛ}_{r} \frac{\partial {E}_{z}}{\partial t} = \frac{\partial {H}_{y}}{\partial x} - \frac{\partial {H}_{x}}{\partial y}$$

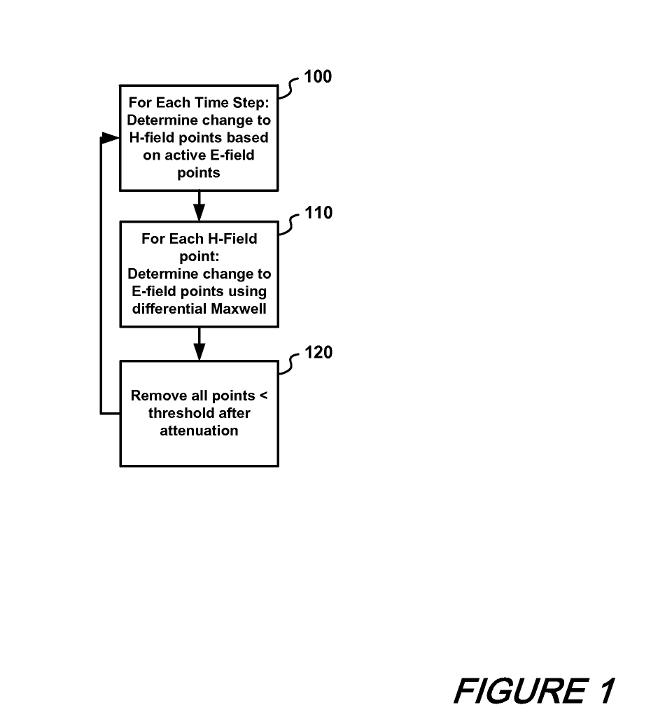

With reference now to FIG. 1 there it shows a schematic flow diagram depicting method steps for performing FDTD according to an aspect of the present disclosure. At step 100, for each time step we start with the list of active E-field points and determine the changes to the H-field points based on these E-field points in the active list using the differential form of Maxwell's equations. This will result in the generation of some new active points that are adjacent to the existing active points.

Next, at step 110, we then iterate through all of the H-field points and determine the changes to the E-field points using the differential form of Maxwell's equations. As before, this will result in some new active E-field points that are adjacent to existing active points.

At step 120, we then remove all the points that exhibit an optical power below a certain threshold value. To make the procedure more stable, prior to removal points may be attenuated gradually over several time steps. The removed points may leave “holes” in the list which are tracked such that they may be refilled, or the lists may be resorted. The cycle repeats.

At the start of the simulation, an electromagnetic pulse is typically launched into the system and then the simulation calculates the pulse as it travels through the system. The pulse is advantageous because it keeps the active lists as short as possible and it allows simulation of many frequencies at once.

Advantageously, a method according to the present disclosure works well for waveguides exhibiting low scattering. If, on the other hand, there is a lot of scattering, the radiation may spread out significantly thereby lengthening the lists and greatly slowing the computation. One solution to this characteristic is to artificially and slowly attenuate energy in the cladding or in a special region of the cladding that is a certain distance from the waveguide. This keeps the scattered light from significantly adding to the field list(s).

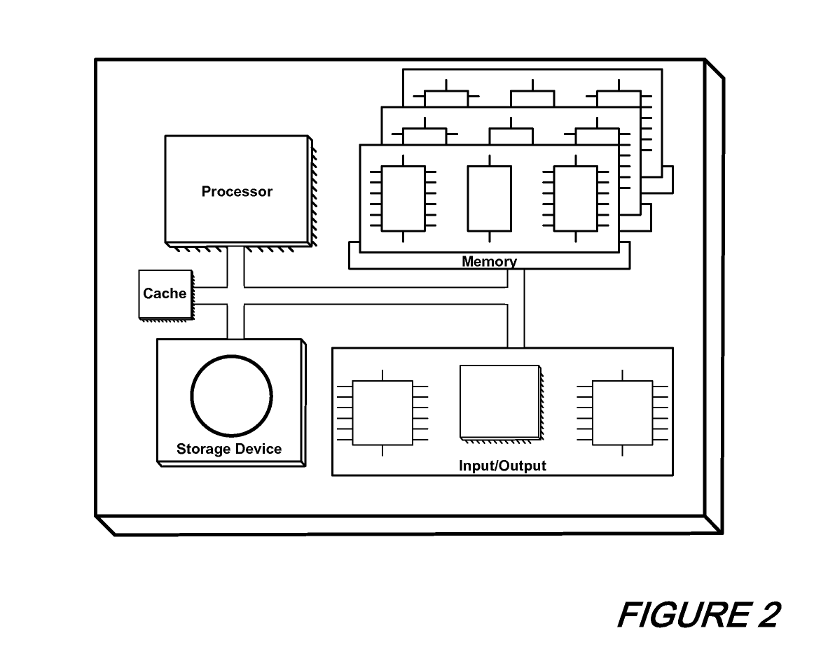

As may be readily appreciated, methods according to the present disclosure advantageously operate on a programmable digital computer such as that depicted schematically in FIG. 2.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A computer-implemented sparse finite difference time domain (FDTD) method of simulating electromagnetic wave propagation comprising the steps of:
by a computer:
a) maintaining a list of active E-field and magnetic field H-field points rather than a full array of points; and
b) outputting an indicia of the E-field and H-field points.

2. The method of claim 1 further comprising the computer-implemented steps of
starting with a list of active E-field and H-field points:
c) determining for each time step, the changes in the H-field points based on the E-field points included in the active list.

3. The method of claim 2 further comprising the computer-implemented steps of
d) determining for each of the H-field points, the changes in the E-field points.

4. The method of claim 3 further comprising the computer-implemented steps of
e) removing any field points having an optical power below a threshold value.

5. The method of claim 4 further comprising the computer-implemented steps of
f) repeating steps a)-e).

6. The method of claim 3 further comprising attenuating field points having an optical power below a threshold value that is higher than the threshold value for removing field points.

7. The method of claim 1 in which the simulation is in two dimensions.

8. The method of claim 1 in which the simulation is in three dimensions.

9. The method of claim 1 in which a pulse is launched into the system.

10. A computer-implemented sparse 3D finite difference time domain (FDTD) method of simulating electromagnetic wave propagation comprising the steps of:
by a computer:
a) maintaining a list of active field points, each element of the list containing the x,y,z location of the point and the amplitude of Ex, Ey, Ez, Hx, Hy, and Hz at the point
b) for each time step, calculating updated Ex, Ey, and Ez amplitudes in the list based on Hx, Hy, Hz values in the list and the permittivity and permeability distribution, calculating updated Hx, Hy, and Hz amplitudes in the list based on the Ex, Ey, Ez values in the list and the permittivity and permeability distribution, and adding new calculated field points to the list
c) removing points from the list when the power at the point has fallen below a specified threshold

10. A computer-implemented sparse 2D finite difference time domain (FDTD) method of simulating electromagnetic wave propagation comprising the steps of:
by a computer:
a) maintaining a list of active field points, each element of the list containing the x,y location of the point and the amplitude of Ex, Ey, and Hz at the point
b) for each time step, calculating updated Ex and Ey amplitudes in the list based on Hz values in the list and the permittivity and permeability distribution, calculating updated Hz amplitudes in the list based on the Ex, Ey values in the list and the permittivity and permeability distribution, and adding new calculated field points to the list
c) removing points from the list when the power at the point has fallen below a specified threshold
